(19) United States
(12) Patent Application Publication
(10) Pub. No.: US 2024/0332539 A1
(43) Pub. Date: Oct. 3, 2024

(54) Positive Electrode Current Collector Coated With Adhesion Enhancement Layer and Positive Electrode for Lithium Secondary Battery and Lithium Secondary Battery Comprising the Same

(71) Applicant: LG Chem, Ltd., Seoul (KR)

(72) Inventors: Min-Soo Kim, Daejeon (KR); Jung-Hyun Seo, Daejeon (KR); Soon-Hwa Jung, Daejeon (KR)

(73) Assignee: LG Chem, Ltd., Seoul (KR)

(21) Appl. No.: 18/575,946

(22) PCT Filed: Oct. 24, 2022
(86) PCT No.: PCT/KR2022/016297

§ 371 Date: Jan. 2, 2024

(30) Foreign Application Priority Data
Nov. 3, 2021 (KR) 10-2021-0150121
Nov. 3, 2021 (KR) 10-2021-0150122

(51) Int. Cl. H01M 4/66; H01M 4/02; H01M 4/136; H01M 4/58; H01M 4/62; H01M 10/0525

(52) U.S. Cl. CPC H01M 4/667; H01M 4/136; H01M 4/5825; H01M 4/623; H01M 4/661; H01M 4/668; H01M 10/0525; H01M 2004/021; H01M 2004/028

(57) ABSTRACT

A positive electrode current collector coated with an adhesion enhancement layer includes an aluminum foil current collector, and an adhesion enhancement layer coated on at least one surface of the aluminum foil current collector. The adhesion enhancement layer includes a first binder polymer and a first conductive material, wherein the adhesion enhancement layer includes 40 to 80 weight % of Al and 1 to 10 weight % of F and has a ratio of F/Al contents of 0.0125 to 0.25 when measured on surfaces of the adhesion enhancement layer by energy-dispersive X-ray spectroscopy (EDX), wherein the first binder polymer includes a first polyvinylidene fluoride-based polymer.

### CROSS-REFERENCE TO RELATED APPLICATIONS

The present application is a national phase entry under 35 U.S.C. § 371 of International Appl. No. PCT/KR2022/016297, filed on Oct. 24, 2022, which claims priority to Korean Patent Application No. 10-2021-0150121 filed on Nov. 3, 2021 and Korean Patent Application No. 10-2021-0150122 filed on Nov. 3, 2021 in the Republic of Korea, the disclosures of which are incorporated herein by reference.

### TECHNICAL FIELD

The present disclosure relates to a positive electrode current collector coated with an adhesion enhancement layer, and a positive electrode for a lithium secondary battery and a lithium secondary battery comprising the same.

### BACKGROUND ART

Recently, with the rapid widespread use of electronic devices using batteries, for example, mobile phones, laptop computers and electric vehicles, there is a fast growing demand for secondary batteries with smaller size, lighter weight and higher capacity. In particular, lithium secondary batteries are gaining attention as a power source for driving mobile devices due to their light weight and high energy density advantages. Accordingly, there are many research and development efforts to improve the performance of lithium secondary batteries.

A lithium secondary battery comprises a positive electrode and a negative electrode made of active materials capable of intercalating and deintercalating lithium ions and an organic electrolyte solution or a polymer electrolyte solution filled between the positive electrode and the negative electrode, and produces electrical energy by oxidation and reduction reactions during the intercalation/deintercalation of lithium ions at the positive electrode and the negative electrode.

In general, the positive electrode of the lithium secondary battery is manufactured by coating a positive electrode active material slurry comprising a positive electrode active material, a conductive material, a binder polymer and a solvent on a positive electrode current collector made of a metal such as aluminum and drying to form a positive electrode active material layer. Specifically, the positive electrode is manufactured by weighing and mixing each constituent material of the positive electrode active material slurry, coating and drying the positive electrode active material slurry on the positive electrode current collector, and pressing.

The manufactured positive electrode is assembled into the lithium secondary battery through post-processing, and there is a likelihood that the positive electrode active material may be detached due to the low adhesion strength of the positive electrode active material layer and the current collector. This problem gets worse when the positive electrode active material is a lithium iron phosphate based positive electrode active material or the size of the active material is smaller.

To solve this problem, forming an adhesion enhancement layer comprising a binder polymer on the current collector before forming the positive electrode active material layer on the current collector has been proposed, but there is a need for the development of adhesion enhancement layers with higher adhesion strength of the positive electrode active material layer to the current collector and low interfacial resistance.

Meanwhile, there is also a need for the manufacture of lithium secondary batteries for maintaining the adhesion strength with electrodes when applied to lithium secondary batteries comprising electrolyte solutions.

### DISCLOSURE

### Technical Problem

An aspect of the present disclosure is directed to providing a positive electrode current collector coated with an adhesion enhancement layer that can improve the adhesion strength between a positive electrode active material layer and a current collector and has low interfacial resistance, and a positive electrode for a lithium secondary battery and a secondary battery comprising the same.

Another aspect of the present disclosure is directed to providing a positive electrode current collector coated with an adhesion enhancement layer for maintaining the adhesion strength with electrodes when applied to lithium secondary batteries comprising electrolyte solutions, and a positive electrode for a lithium secondary battery and a secondary battery comprising the same.

### Technical Solution

An aspect of the present disclosure provides a positive electrode current collector coated with an adhesion enhancement layer according to the following embodiment.

A first embodiment relates to the positive electrode current collector coated with an adhesion enhancement layer comprising an aluminum foil current collector; and an adhesion enhancement layer coated on at least one surface of the aluminum foil current collector, the adhesion enhancement layer comprising a first binder polymer and a first conductive material, wherein the adhesion enhancement layer comprises from 40 to 80 weight % of Al and 1 to 10 weight % of F and has a ratio of F/Al contents of 0.0125 to 0.25 when measured on surfaces of the adhesion enhancement layer by energy-dispersive X-ray spectroscopy (EDX), wherein the first binder polymer comprises a first polyvinylidene fluoride-based polymer.

A second embodiment relates to the positive electrode current collector coated with an adhesion enhancement layer according to the first embodiment, wherein the first binder polymer is distributed in island arrays over the surface of the aluminum foil current collector.

A third embodiment relates to the positive electrode current collector coated with an adhesion enhancement layer according to the first or second embodiment, wherein the adhesion enhancement layer comprises from 45 to 75 weight % of Al and from 2 to 8 weight % of F when measured on surfaces by EDX.

A fourth embodiment relates to the positive electrode current collector coated with an adhesion enhancement layer according to the first to third embodiments, wherein the adhesion enhancement layer has the ratio of F/Al contents of 0.027 to 0.178 when measured on surfaces of the adhesion enhancement layer by EDX.

A fifth embodiment relates to the positive electrode current collector coated with an adhesion enhancement layer according to the first to fourth embodiments, wherein a surface roughness (Ra) of the adhesion enhancement layer is from 90 to 600 nm.

A sixth embodiment relates to the positive electrode current collector coated with an adhesion enhancement layer according to the first to fifth embodiments, wherein the adhesion enhancement layer has a contact angle of a diiodomethane droplet of 700 to 120°.

A seventh embodiment relates to the positive electrode current collector coated with an adhesion enhancement layer according to the first to sixth embodiments, wherein a melting point of the first polyvinylidene fluoride-based polymer is from 50° C. to 150° C., more specifically, from 70° C. to 150° C., and most specifically from 90° C. to 150° C.

An eighth embodiment relates to the positive electrode current collector coated with an adhesion enhancement layer according to the first to seventh embodiments, wherein the first polyvinylidene fluoride-based polymer is a copolymer of vinylidene fluoride and hexafluoropropylene.

A ninth embodiment relates to the positive electrode current collector coated with an adhesion enhancement layer according to any one of the first to eighth embodiments, wherein a weight average molecular weight of the first polyvinylidene fluoride-based polymer is from 700,000 to 1,300,000, and more specifically from 800,000 to 1,100,000.

A tenth embodiment relates to the positive electrode current collector coated with an adhesion enhancement layer according to any one of the first to ninth embodiments, wherein a weight ratio of the first polyvinylidene fluoride-based polymer and the first conductive material is from 0.5:1 to 8:1.

An eleventh embodiment relates to the positive electrode current collector coated with an adhesion enhancement layer according to any one of the first to tenth embodiments, wherein a thickness of the adhesion enhancement layer on one surface of the at least one surface of the aluminum foil current collector is from 50 to 5,000 nm.

A twelfth embodiment provides a positive electrode for a lithium secondary battery comprising the positive electrode current collector coated with the adhesion enhancement layer according to any one of the first to eleventh embodiments; and a positive electrode active material layer on the adhesion enhancement layer, the positive electrode active material layer comprising a positive electrode active material, a second conductive material and a second binder polymer.

A thirteenth embodiment relates to the positive electrode for a lithium secondary battery according to the twelfth embodiment, wherein the positive electrode active material is represented by the following Formula 1:

Li₁₊ₐFe₁₋ₓMₓ(PO_{4-b})X_{b} <Formula 1>

wherein M is at least one selected from the group consisting of Al, Mg, Ni, Co, Mn, Ti, Ga, Cu, V, Nb, Zr, Ce, In, Zn and Y, X is at least one selected from the group consisting of F, S and N, −0.5≤a≤+0.5, 0≤x≤0.5, and 0≤b≤0.1.

A fourteenth embodiment relates to the positive electrode for a lithium secondary battery according to the twelfth or thirteenth embodiment, wherein the second binder polymer is a second polyvinylidene fluoride-based polymer.

A fifteenth embodiment provides a lithium secondary battery comprising the positive electrode according to the twelfth to fourteenth embodiments, a negative electrode opposite the positive electrode, a separator between the positive electrode and the negative electrode, and an electrolyte.

### Advantageous Effects

According to an embodiment of the present disclosure, the adhesion enhancement layer improves the adhesion strength between the positive electrode active material layer and the current collector and exhibits low interfacial resistance. In particular, the adhesion enhancement layer comprising the polyvinylidene fluoride-based polymer distributed in island arrays over the surface of the aluminum foil current collector does not cover the entire surface of the current collector and the aluminum foil current collector is exposed at a predetermined percentage. Accordingly, the adhesion enhancement layer improves the positive electrode active material layer and the current collector and exhibits lower interfacial resistance.

Additionally, the adhesion enhancement layer using the polyvinylidene fluoride-based polymer having a predetermined melting point range according to an embodiment maintains higher resistance to dissolution in the electrolyte solution and higher adhesion strength with the positive electrode active material layer when applied to lithium secondary batteries comprising electrolyte solutions.

Furthermore, the adhesion enhancement layer having a predetermined surface roughness (Ra) range according to an embodiment maintains a tighter contact with the positive electrode active material layer, thereby improving the adhesion strength, and the adhesion enhancement layer having a predetermined contact angle range of a diiodomethane droplet prevents the adhesion strength decline and the resistance rise caused by the swelling of the adhesion enhancement layer due to the positive electrode active material layer solvent and further improves the resistance to dissolution in the electrolyte solution when applied to lithium secondary batteries comprising electrolyte solutions.

### DESCRIPTION OF DRAWINGS

The accompanying drawings illustrate an exemplary embodiment of the present disclosure, and together with the foregoing description of the present disclosure, serve to help a further understanding of the technical aspect of the present disclosure, so the present disclosure should not be construed as being limited to the drawings. Meanwhile, the shape, size, scale or proportion of the elements in the accompanying drawings may be exaggerated to emphasize a more clear description.

FIG. 1 is a scanning electron microscopy (SEM) image of an adhesion enhancement layer according to example 1.

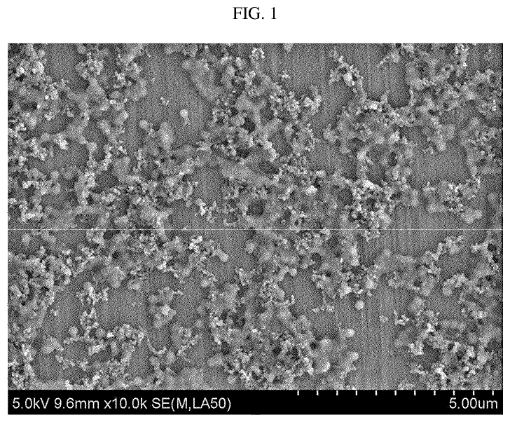

FIG. 2 is a differential scanning calorimetry (DSC) chart of polymer A used in example 1.

### BEST MODE

Hereinafter, an embodiment of the present disclosure will be described in detail. Prior to the description, it should be understood that the terms or words used in the specification and the appended claims should not be construed as limited to general and dictionary meanings, and should be interpreted based on the meanings and concepts corresponding to technical aspect of the present disclosure on the basis of the principle that the inventor is allowed to define terms appropriately for the best explanation. Therefore, the disclosure of the embodiments described herein is an exemplary embodiment of the present disclosure, but not intended to fully describe the technical aspects of the present disclosure, so it should be understood that a variety of other equivalents and modifications could have been made thereto at the time that the application was filed.

A positive electrode current collector coated with an adhesion enhancement layer according to an aspect of the present disclosure comprises:
an aluminum foil current collector; and
an adhesion enhancement layer coated on at least one surface of the aluminum foil current collector, and comprising a first binder polymer and a first conductive material, wherein the adhesion enhancement layer comprises 40 to 80 weight % of Al and 1 to 10 weight % of F and has a ratio of F/Al contents of 0.0125 to 0.25 when measured on surfaces by energy-dispersive X-ray spectroscopy (EDX),
wherein the first binder polymer comprises a polyvinylidene fluoride-based polymer.

For the positive electrode current collector, a metal current collector such as aluminum is used. In particular, aluminum may be used in the form of a foil, and the aluminum foil easily oxidizes in air to form a surface layer of aluminum oxide.

Accordingly, the aluminum foil current collector should be interpreted as encompassing the current collector having the aluminum oxide surface layer formed by the oxidation of aluminum on the surface. The thickness of the aluminum foil current collector may be typically 3 to 500 m, but is not limited thereto.

The adhesion enhancement layer is coated on at least one surface of the aluminum foil current collector.

The adhesion enhancement layer comprises the first binder polymer to improve the adhesion strength of the metal current collector and the positive electrode active material layer, and in the present disclosure, the polyvinylidene fluoride-based polymer is included as the first binder polymer.

Preferably, the melting point of the polyvinylidene fluoride-based polymer is 50 to 150° C. When the polyvinylidene fluoride-based polymer has the above-described melting point range, it is possible to reduce the likelihood of dissolution in the electrolyte solution used in the battery assembly and increase the adhesion strength with the electrode. In this view, more specifically, the melting point of the polyvinylidene fluoride-based polymer may be 70 to 150° C., more specifically 90 to 150° C., and most specifically 100 to 140° C. The polyvinylidene fluoride-based polymer may include, for example, a copolymer of vinylidene fluoride and hexafluoropropylene, but is not limited thereto.

The weight average molecular weight of the polyvinylidene fluoride-based polymer may be 700,000 to 1,300,000, and more specifically 800,000 to 1,100,000. When the weight average molecular weight is in the above-described range, it is possible to further enhance the adhesion strength with the positive electrode active material layer.

Additionally, the adhesion enhancement layer comprises the first conductive material to suppress the resistance rise of the positive electrode. The first conductive material may include, without limitation, any type of conductive material that has conductive properties without causing side reaction with the other elements of the battery, for example, graphite such as natural graphite or artificial graphite; carbon black such as carbon black (super-p), acetylene black, ketjen black, channel black, furnace black, lamp black, thermal black; conductive fibers such as carbon fibers or metal fibers; carbon nanotubes such as MW-CNT, SW-CNT; metal powder such as fluorocarbon, aluminum and nickel powder; conductive whiskers such as zinc oxide and potassium titanate; conductive metal oxide such as titanium oxide; or conductive materials such as polyphenylene derivatives, and they may be used singly or in combination to reduce the interfacial resistance.

Meanwhile, the first binder polymer of the adhesion enhancement layer may be distributed in island arrays on the surface of the aluminum foil current collector. That is, the polyvinylidene fluoride-based polymer distributed in island arrays does not cover the entire surface of the current collector and the aluminum foil current collector is exposed at a predetermined percentage. Accordingly, the adhesion enhancement layer improves the adhesion strength between the positive electrode active material layer and the current collector and exhibits low interfacial resistance.

The adhesion enhancement layer comprises 40 to 80 weight % of Al and 1 to 10 weight % of F and has the ratio of F/Al contents of 0.0125 to 0.25 when measured on surfaces by EDX. Here, the Al content is related to the percentage of the aluminum foil current collector that is not coated with the adhesion enhancement layer. Additionally, the F content is an amount attributed to the polyvinylidene fluoride-based polymer of the adhesion enhancement layer coated on the surface of the aluminum foil current collector. When the ratio of F/Al contents is less than 0.0125, the adhesion strength of the adhesion enhancement layer to the positive electrode active material layer is too low due to the increased percentage of the aluminum foil current collector that is exposed, not coated with the polyvinylidene fluoride-based polymer, and when the content ratio is larger than 0.25, on the contrary, the coating percentage of the adhesion enhancement layer comprising the polyvinylidene fluoride-based polymer increases and the interfacial resistance is too high.

In this view, the adhesion enhancement layer may comprise 45 to 75 weight % of Al and 2 to 8 weight % of F and have the ratio of F/Al contents of 0.027 to 0.178, when measured on surfaces by EDX.

Meanwhile, the surface roughness (Ra) of the adhesion enhancement layer may be 90 to 600 nm. When the surface roughness (Ra) of the adhesion enhancement layer has the above-described range, it is possible to further enhance the adhesion strength with the positive electrode active material layer. In this view, the surface roughness (Ra) of the adhesion enhancement layer may be 110 to 550 nm, and more specifically 119 to 522 nm.

Additionally, the contact angle of a diiodomethane droplet on the adhesion enhancement layer may be 700 and 120°. When the adhesion enhancement layer has the contact angle of a diiodomethane droplet within the above-described range, it is possible to maintain low interfacial resistance and have good resistance to dissolution in the non-aqueous electrolyte solution, thereby further improving the adhesion strength with the positive electrode active material layer when applied to lithium secondary batteries comprising electrolyte solutions. In this view, the contact angle of a diiodomethane droplet on the adhesion enhancement layer may be 80° to 110°, and more specifically 980 to 105°.

In addition to the polyvinylidene fluoride-based polymer and the first conductive material, the adhesion enhancement layer may further comprise any other binder polymer, dispersants or additives without departing from the objective of the present disclosure.

The weight ratio of the polyvinylidene fluoride-based polymer and the first conductive material in the adhesion enhancement layer may be 0.5:1 to 8:1, but is not limited thereto. Additionally, the thickness of the adhesion enhancement layer on one surface of the metal current collector may be 50 to 5,000 nm.

The positive electrode current collector coated with the adhesion enhancement layer configured as described above may be manufactured by the following method.

First, an aqueous slurry comprising the first binder polymer comprising the polyvinylidene fluoride-based polymer particles and the first conductive material is prepared.

The slurry for forming the adhesion enhancement layer is an aqueous slurry using water as a dispersion medium.

The aqueous slurry may further comprise selectively a solvent, for example, isopropyalcohol, acetone, ethanol and butyl alcohol to reduce the surface energy and improve the coating performance.

The use of the particulate polyvinylidene fluoride-based polymer in the aqueous slurry reduces the resistance rise of the adhesion enhancement layer. The aqueous slurry may further comprise at least one type of thickening agent to control the viscosity. In particular, the thickening agent may include carboxymethylcellulose, hydroxymethylcellulose, ethylcellulose, polyvinylalcohol, casein and methylcellulose, but is not limited thereto. In addition to the above-described components, the aqueous slurry may further include any other additive, for example, a dispersant without departing from the objective of the present disclosure.

Subsequently, the prepared aqueous slurry is coated on at least one surface of the aluminum foil current collector, and dried by thermal treatment at higher temperature than the melting point of the polyvinylidene fluoride-based polymer particles to form the adhesion enhancement layer.

The common slurry coating methods and devices may be used to coat the aqueous slurry on the aluminum foil current collector, and the coating methods may include, for example, a bar coating method such as Meyer bar, a gravure coating method, a 2 roll reverse coating method, a vacuum slot die coating method and a 2 roll coating method. The aluminum foil current collector coated with the aqueous slurry is dried by thermal treatment at higher temperature than the melting point of the polyvinylidene fluoride-based polymer particles to form the adhesion enhancement layer. Specifically, the drying process may be performed at higher temperature than the melting point of the polyvinylidene fluoride-based polymer particles by 10° C. to 80° C., but is not limited thereto.

When dried by thermal treatment at higher temperature than the melting point of polyvinylidene fluoride-based polymer particles, the polyvinylidene fluoride-based polymer particles melt, and as the temperature decreases during the drying process, they are solidified to form the adhesion enhancement layer bonded onto the metal current collector. In this instance, the polyvinylidene fluoride-based polymer of the adhesion enhancement layer may be distributed in island arrays over the surface of the current collector. That is, the polyvinylidene fluoride-based polymer distributed in island arrays does not cover the entire surface of the current collector. Accordingly, the adhesion enhancement layer improves the adhesion strength between the positive electrode active material layer and the current collector and has lower interfacial resistance.

Additionally, as the polyvinylidene fluoride-based polymer having the predetermined melting point range is preferably used as described above, it is possible to dry the aqueous slurry at relatively low temperature to reduce energy consumption, and maintain high resistance to dissolution in the electrolyte solution and high adhesion strength with the positive electrode active material layer when applied to lithium secondary batteries comprising electrolyte solutions.

According to another embodiment of the present disclosure, there may be provided a positive electrode for a lithium secondary battery comprising a positive electrode active material layer on the adhesion enhancement layer, and comprising a positive electrode active material, a second conductive material and a second binder polymer.

The positive electrode active material layer comprises the positive electrode active material, the second conductive material and the second binder polymer, in the same way as the common positive electrode active material layers for lithium secondary batteries. The positive electrode active material may include the common positive electrode active materials used in lithium secondary batteries, for example, lithium transition metal oxide. In particular, the positive electrode active material may include positive electrode active materials represented by the following Formula 1.

Li₁₊ₐFe₁₋ₓMₓ(PO_{4-b})X_{b} <Formula 1>

(M is at least one selected from the group consisting of Al, Mg, Ni, Co, Mn, Ti, Ga, Cu, V, Nb, Zr, Ce, In, Zn and Y, and X is at least one selected from the group consisting of F, S and N, −0.5≤a≤+0.5, 0≤x≤0.5, 0≤b≤0.1)

The positive electrode active material of the above Formula 1 is a lithium iron phosphate-based compound, and has low adhesion strength especially with the aluminum foil current collector. Accordingly, there is a growing industrial need for the improved adhesion strength with the aluminum foil current collector by the use of the adhesion enhancement layer according to the present disclosure.

The second binder polymer used to bind the positive electrode active material may typically include binder polymers applied to positive electrode materials, for example, at least one of polyvinylidene fluoride (PVDF), polyvinylidene fluoride-hexafluoropropylene copolymer (PVDF-co-HFP), polyvinylalcohol, polyacrylonitrile, carboxymethylcellulose (CMC), starch, hydroxypropyl cellulose, regenerated cellulose, polyvinylpyrrolidone, tetrafluoroethylene, polyethylene, polypropylene, ethylene-propylene-diene polymer (EPDM), sulfonated-EPDM, styrene butadiene rubber (SBR), fluoro rubber, or a variety of copolymers thereof. More preferably, the second binder polymer may include a polyvinylidene fluoride-based polymer, and interaction with the polyvinylidene fluoride-based polymer of the adhesion enhancement layer increases the interlayer adhesion strength improvement effect.

The second binder polymer may be, for example, included in an amount of 1 to 30 weight % based on the total weight of the positive electrode active material layer.

For the second conductive material used in the positive electrode active material layer may be used independently of the first conductive material of the adhesion enhancement layer. The second conductive material may be typically included in an amount of 1 to 30 weight % based on the total weight of the positive electrode active material layer.

The positive electrode for a lithium secondary battery may be manufactured by manufacturing the positive electrode current collector coated with the adhesion enhancement layer by the above-described manufacturing method, and stacking on and attaching to the adhesion enhancement layer, the positive electrode active material layer comprising the positive electrode active material, the second conductive material and the second binder polymer.

The method for stacking the positive electrode active material layer and attaching it to the adhesion enhancement layer may include the methods commonly used in the corresponding technical field.

For example, a positive electrode active material layer forming composition comprising the positive electrode active material, the second conductive material and the second binder polymer may be coated on the adhesion enhancement layer, followed by drying and pressing.

In this instance, a solvent used in the positive electrode active material layer forming composition may include solvents commonly used in the corresponding technical field, for example, at least one of dimethyl sulfoxide (DMSO), isopropyl alcohol, N-methylpyrrolidone (NMP), acetone or water. The solvent may be used in such an amount so as to have sufficient viscosity for achieving good thickness uniformity when dissolving the binder polymer, dispersing the conductive material and the positive electrode active material, and subsequently, coating for manufacturing the positive electrode in view of the coating thickness of the coating solution and the production yield.

The polyvinylidene fluoride-based polymer included in the adhesion enhancement layer has flowability when subjected to heat and pressure. For example, when subjected to heat and pressure at higher temperature than the glass transition temperature of the polyvinylidene fluoride-based polymer in the temperature range of the melting point (Tm) of the polymer−60° C. to the melting point (Tm) of the binder polymer+60° C., more specifically the temperature range of the melting point (Tm) of the binder polymer−50° C. to the melting point (Tm) of the binder polymer+50° C., and more specifically the temperature range of the melting point (Tm) of the binder polymer−40° C. to the melting point (Tm) of the binder polymer+30° C., the binder polymer of the adhesion enhancement layer becomes flowable by the heat and attaches to the surface layer of the positive electrode active material layer in contact with the adhesion enhancement layer.

In the positive electrode for a lithium secondary battery according to an aspect manufactured by the above-described manufacturing method, the thickness of the positive electrode active material layer (the thickness of the positive electrode active material layer on one surface of the adhesion enhancement layer, not two surfaces of the adhesion enhancement layer, after pressing) may be 40 to 200 μm, but is not limited thereto.

According to another embodiment of the present disclosure, there is provided a lithium secondary battery comprising the above-described positive electrode.

Specifically, the lithium secondary battery comprises the positive electrode, a negative electrode opposite the positive electrode, a separator between the positive electrode and the negative electrode and an electrolyte, and the positive electrode is the same as described above. Additionally, optionally, the lithium secondary battery may further comprise a battery case accommodating an electrode assembly comprising the positive electrode, the negative electrode and the separator, and a sealing member to seal up the battery case.

In the lithium secondary battery, the negative electrode comprises a negative electrode current collector and a negative electrode active material layer on the negative electrode current collector.

The negative electrode current collector is not limited to a particular type and may include those having high conductivity without causing any chemical change to the battery, for example, copper, stainless steel, aluminum, nickel, titanium, sintered carbon, copper or stainless steel treated with carbon, nickel, titanium or silver on the surface and an aluminum-cadmium alloy, but is not limited thereto. Additionally, the negative electrode current collector may be typically 3 to 500 μm in thickness, and in the same way as the positive electrode current collector, the negative electrode current collector may have microtexture on the surface to improve the bonding strength with the negative electrode active material.

For example, the negative electrode current collector may come in various forms, for example, films, sheets, foils, nets, porous bodies, foams and non-woven fabrics. In addition to the negative electrode active material, the negative electrode active material layer optionally comprises a binder and a conductive material. For example, the negative electrode active material layer may be formed by applying a negative electrode forming composition comprising the negative electrode active material, and optionally the binder and the conductive material on the negative electrode current collector and drying, or by casting the negative electrode forming composition on a support, peeling off a film from the support and laminating the film on the negative electrode current collector.

The negative electrode active material may include compounds capable of reversibly intercalating and deintercalating lithium. Specific examples may include at least one of a carbonaceous material, for example, artificial graphite, natural graphite, graphitizing carbon fibers, amorphous carbon; a metallic compound that can form an alloy with lithium, for example, Si, Al, Sn, Pb, Zn, Bi, In, Mg, Ga, Cd, a Si alloy, a Sn alloy or an Al alloy; metal oxide capable of doping and undoping lithium such as SiO3 (0<3<2), SnO₂, vanadium oxide, lithium vanadium oxide; or a complex comprising the metallic compound and the carbonaceous material such as a Si—C complex or a Sn—C complex. Additionally, a metal lithium thin film may be used for the negative electrode active material. Additionally, the carbon material may include low crystalline carbon and high crystalline carbon. The low crystalline carbon typically includes soft carbon and hard carbon, and the high crystalline carbon typically includes high temperature sintered carbon, for example, amorphous, platy, flaky, spherical or fibrous natural graphite or artificial graphite, Kish graphite, pyrolytic carbon, mesophase pitch based carbon fibers, meso-carbon microbeads, mesophase pitches and petroleum or coal tar pitch derived cokes.

Additionally, the binder and the conductive material may be the same as those of the positive electrode described above.

On the other hand, in the lithium secondary battery, the separator separates the negative electrode from the positive electrode and provides a passage for movement of lithium ions, and may include, without limitation, any separator commonly used in lithium secondary batteries, and in particular, preferably, those having low resistance to the electrolyte ion movement and good electrolyte solution wettability. Specifically, the separator may include, for example, a porous polymer film made of a polyolefin-based polymer such as an ethylene homopolymer, a propylene homopolymer, an ethylene/butene copolymer, an ethylene/hexene copolymer and an ethylene/methacrylate copolymer or a stack structure of two or more porous polymer films. Additionally, the separator may include common porous non-woven fabrics, for example, non-woven fabrics made of high melting point glass fibers and polyethylene terephthalate fibers. Additionally, to ensure the heat resistance or mechanical strength, coated separators comprising ceramics or polymer materials may be used, and may be selectively used with a mono- or multi-layer structure.

Additionally, the electrolyte used in the present disclosure may include an organic liquid electrolyte, an inorganic liquid electrolyte, a solid polymer electrolyte, a gel polymer electrolyte, a solid inorganic electrolyte and a molten inorganic electrolyte, available in the manufacture of lithium secondary batteries, but is not limited thereto.

Specifically, the electrolyte may be an electrolyte solution comprising an organic solvent and a lithium salt.

The organic solvent may include, without limitation, any type of organic solvent that acts as a medium for the movement of ions involved in the electrochemical reaction of the battery. Specifically, the organic solvent may include an ester-based solvent, for example, methyl acetate, ethyl acetate, y-butyrolactone, F-caprolactone; an ether-based solvent, for example, dibutyl ether or tetrahydrofuran; a ketone-based solvent, for example, cyclohexanone; an aromatic hydrocarbon-based solvent, for example, benzene, fluorobenzene; a carbonate-based solvent, for example, dimethylcarbonate (DMC), diethylcarbonate (DEC), methylethylcarbonate (MEC), ethylmethylcarbonate (EMC), ethylene carbonate (EC), propylene carbonate (PC); an alcohol-based solvent, for example, ethylalcohol, isopropyl alcohol; nitriles of R-CN (R is a C2 to C20 straight-chain, branched-chain or cyclic hydrocarbon, and may comprise an exocyclic double bond or ether bond); amides, for example, dimethylformamide; dioxolanes, for example, 1,3-dioxolane; or sulfolanes. Among them, the carbonate-based solvent is desirable, and more preferably, the cyclic carbonate (for example, ethylene carbonate or propylene carbonate) having high ionic conductivity and high dielectric constant which contributes to the improved charge/discharge performance of the battery may be mixed with the linear carbonate-based compound (for example, ethylmethyl carbonate, dimethyl carbonate or diethyl carbonate) of low viscosity. In this case, the cyclic carbonate and the chain carbonate may be mixed at a volume ratio of about 1:1 to about 1:9 to improve the performance of the electrolyte solution.

The lithium salt may include, without limitation, any compound that can provide lithium ions used in lithium secondary batteries. Specifically, the lithium salt may include LiPF₆, LiClO₄, LiAsF₆, LiBF₄, LiSbF₆, LiAl0₄, LiAlCl₄, LiCF₃SO₃, LiC₄F₉SO₃, LiN(C₂F₅SO₃)₂, LiN(C₂F₅SO₂)₂, LiN(CF₃SO₂)₂. LiCl, LiI or LiB(C₂O₄)₂. The concentration of the lithium salt may range from 0.1 to 2.0M. When the concentration of the lithium salt is included in the above-described range, the electrolyte has the optimal conductivity and viscosity, resulting in good performance of the electrolyte and effective movement of lithium ions.

In addition to the above-described constituent substances of the electrolyte, the electrolyte may further comprise, for example, at least one type of additive of a haloalkylene carbonate-based compound such as difluoro ethylene carbonate, pyridine, triethylphosphite, triethanolamine, cyclic ether, ethylene diamine, n-glyme, hexaphosphoric triamide, nitrobenzene derivatives, sulfur, a quinone imine dye, N-substituted oxazolidinone, N,N-substituted imidazolidine, ethylene glycol dialkyl ether, an ammonium salt, pyrrole, 2-methoxy ethanol or aluminum trichloride to improve the life characteristics of the battery, prevent the capacity fading of the battery and improve the discharge capacity of the battery. In this instance, the additive may be included in an amount of 0.1 to 5 weight % based on the total weight of the electrolyte.

The lithium secondary battery is useful in the field of mobile devices including mobile phones, laptop computers and digital cameras, and electric vehicles including hybrid electric vehicles (HEVs).

Accordingly, according to another embodiment of the present disclosure, there are provided a battery module comprising the lithium secondary battery as a unit cell and a battery pack comprising the same.

The battery module or the battery pack may be used as a power source of at least one medium- and large-scale device of power tools; electric vehicles including electric vehicles (EVs), hybrid electric vehicles, and plug-in hybrid electric vehicles (PHEVs); or energy storage systems.

Hereinafter, the embodiment of the present disclosure will be described in sufficiently detail for those having ordinary skill in the technical field pertaining to the present disclosure to easily practice the present disclosure. However, the present disclosure may be embodied in many different forms and is not limited to the disclosed embodiment.

### Example 1

Polymer A (Solvay, a copolymer of vinylidene fluoride and hexafluoropropylene, VDF:HFP=3:1 (weight ratio), average particle size: 250 nm, melting point: 100° C., Mw=1,080,000)] as a first binder polymer and denka carbon black (BET=60 m²/g, DBP=200 ml/100 g) were dispersed in water at a weight ratio of 2:1, and Daicel 2200 as a thickening agent was fed at ⅕ of the weight of the binder polymer to prepare an aqueous slurry comprising 10% solids. Subsequently, the aqueous slurry was coated on two surfaces of a m thick aluminum foil using a Micro gravure coater and dried at 120° C. for 3 min to form an adhesion enhancement layer on the aluminum foil. A positive electrode active material slurry prepared by mixing LiFe(PO₄), polyvinylidene fluoride (Mw=630,000) as a second binder polymer and denka carbon black (BET=60 m²/g, DBP=200 ml/100 g) at 96:2:2 was coated on the adhesion enhancement layer, dried at 140° C. for 10 min and pressed to manufacture a positive electrode.

A lithium metal was used for a negative electrode, and the negative electrode and the positive electrode were stacked with a separator (Celgard) interposed between the negative electrode and the positive electrode to manufacture an electrode assembly. The electrode assembly was punched into a coin shape, and an electrolyte solution in which 1M LiPF6 was dissolved in a mixed solvent (PC:EMC:EC=3:4:3) of propylene carbonate (PC), ethylmethyl carbonate (EMC) and ethylene carbonate (EC) was injected to manufacture a test lithium secondary battery.

### Examples 2-3

The same process as example 1 was performed except that changes were made as shown in the following Table 1.

### Example 4

The same process as example 1 was performed except that for the first binder polymer, polymer B (Solvay, a copolymer of vinylidene fluoride and hexafluoropropylene, VDF:HFP=97:3 (weight ratio), average particle size: 250 nm, melting point: 140° C., Mw=800,000)] was used, and changes were made as shown in the following Table 1.

### Example 5

The same process as example 1 was performed except that the positive electrode active material slurry comprised LiNi_{0.50}Co_{0.20}Mn_{0.30}O₂ instead of LiFe(PO₄), polyvinylidene fluoride (Mw=630,000) as the second binder polymer and Super-P as the second conductive material at the weight ratio of 97.5:1.5:1.

### Comparative Example 1

The same process as example 1 was performed except that changes were made as shown in the following Table 1.

### Comparative Example 2

The same process as example 1 was performed except that chitosan was used instead of polymer A and drying was performed at 170° C.

### Example 6

The same process as example 1 was performed except that changes were made as shown in the following Table 2.

### Examples 7-8

The same process as example 1 was performed except that changes were made as shown in the following Table 2.

### Example 9

The same process as example 6 was performed except that for the first binder polymer, polymer B (Solvay, a copolymer of vinylidene fluoride and hexafluoropropylene, VDF:HFP=97:3 (weight ratio), average particle size: 250 nm, melting point: 140° C., Mw=800,000)] was used, and changes were made as shown in the following Table 1.

### Example 10

The same process as example 6 was performed except that the positive electrode active material slurry comprised LiNi_{0.50}Co_{0.20}Mn_{0.30}O₂ instead of LiFe(PO₄), polyvinylidene fluoride (Mw=630,000) as the second binder polymer and Super-P as the second conductive material at the weight ratio of 97.5:1.5:1.

### Comparative Example 3

The same process as example 6 was performed except that changes were made as shown in the following Table 2.

### Comparative Example 4

The same process as example 6 was performed except that the adhesion enhancement layer was formed as below.

Polymer C (Solvay, polyvinylidene fluoride, melting point: 168° C., Mw=880,000] as a first binder polymer and denka carbon black (product name: Li-250) were added at a weight ratio of 2:1 to prepare an 10% organic slurry in which the denka carbon black was dispersed and the polymer C was dissolved in NMP. Subsequently, the organic slurry was coated on two surfaces of a 20 m thick aluminum foil and dried at 120° C. for 3 min to form an adhesion enhancement layer on the aluminum foil.

### <Measurement of Proportion of Surface Element Content in Adhesion Enhancement Layer>

For each positive electrode current collector coated with the adhesion enhancement layer according to the examples and comparative examples, EDS Mapping was performed at 100 randomly selected locations with ×10,000 magnification in the acceleration voltage condition of 5Kv using FESEM equipment (JEOL JSM-7900F). The Al and F contents measured at 100 locations and their ratio were averaged to calculate the amount of each element and their ratio.

### <Measurement of Surface Roughness (Ra) of Adhesion Enhancement Layer>

Laser scanning was performed in an auto measurement mode by focusing on the surface with 150× magnification using KEYENCE VK-X100K.

The surface roughness Ra value was measured all over the areas to be measured in accordance with JIS B0601:2001. 10 points were measured with the movement by 1 mm, and an average value of Ra was calculated.

### <Measurement of Contact Angle of a Diiodomethane Droplet on Adhesion Enhancement Layer>

After dripping 3 uL of diiodomethane in room temperature condition using KRUSS DSA100 contact angle meter, the average of ten contact angles measured for 10 see was measured.

### <Measurement of Average Particle Size of Polymer Particles>

The polymer particles are scanned by SEM and the average particle size was measured by averaging the lengths of long axes of the primary particles.

### <Measurement of Average Particle Size of Conductive Material>

The average particle size D50 of the conductive material was measured using laser diffraction. The conductive material was dispersed in a dispersion medium and the average particle size D50 at 50% of the particle size distribution was calculated using a laser diffraction particle size measurement equipment (Microtac MT 3000).

### <Measurement of Melting Point of Binder Polymer>

The melting point of the binder polymer was measured using differential scanning calorimetry (DSC).

5 to 10 mg of specimen was fed using TA DSC2500, and thermal scanning was performed with the increasing temperature at the heating rate of 10° C./min from 50° C. to 250° C. under a nitrogen atmosphere, the decreasing temperature at the cooling rate of 10° C./min, and the increasing temperature at the heating rate of 10° C./min from 50° C. to 250° C.

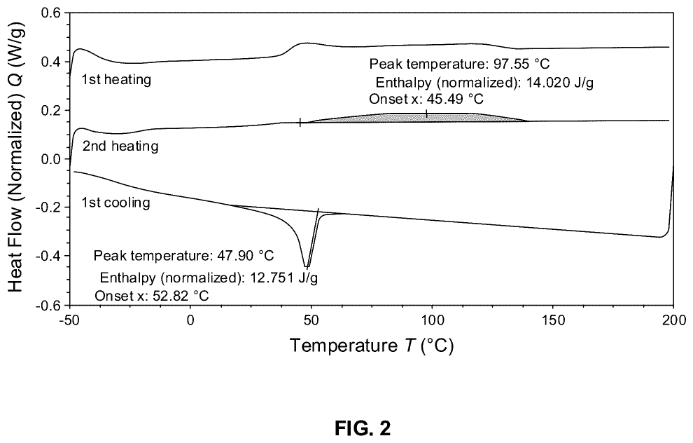

FIG. 2 is a DSC chart of the polymer A of example 1. Referring to FIG. 2, a melting point may be obtained by endothermic peaks during 2^{nd} heating, and the melting point is found to be the temperature at the peak apex.

### <Measurement of Weight Average Molecular Weight of Polymer>

0.04 g of polymer was taken and dissolved in 10 g of tetrahydrofuran to prepare a sample specimen, and a reference specimen (polystyrene) and the sample specimen were filtered through a filter having the pore size of 0.45 m, and injected into a GPC injector.

The number average molecular weight, the weight average molecular weight and the polydispersity of the acrylic polymer were measured by comparing the elution time of the sample specimen with the calibration curve of the reference specimen. The measurements were made at the flow rate of 1.00 mL/min and the column temperature of 35.0° C. using GPC (Infinity 111260, Agilent).

### <Adhesion Strength Evaluation>

The positive electrodes manufactured according to the examples and comparative examples were punched into a size of 2 cm (width)×10 cm (length) or more using a punching machine. Glass was used for a base plate (2.5 cm (width)×7.5 cm (length)×1T (thickness)), a 3M double-sided tape was attached to the glass, and the punched electrode was attached in parallel. The electrode attached to the tape was 6 cm, and the adhesion strength of the electrode was measured while maintaining 900 with the base plate using a texture analyzer (LLOYD).

### <WET Adhesion Strength Evaluation>

The WET adhesion strength evaluation was performed by storing the electrode coated foil through a vacuum drying oven at 130° C. for 24 hr to remove moisture, receiving the electrode in an aluminum pouch together with the electrolyte solution, sealing up the aluminum pouch, storing in the 70° C. oven for 2 weeks and measuring the adhesion strength. In this instance, to remove the remaining electrolyte solution, the electrode was washed using a DMC washing solution and completely dried, and measurements were made. As the adhesion enhancement layer was less resistant to dissolution than before the evaluation of the resistance to the electrolyte solution, the adhesion strength of the adhesion enhancement layer to the electrolyte solution was lower when applied to lithium secondary batteries.

### <Interfacial Resistance Evaluation>

The positive electrodes manufactured according to the examples and comparative examples were punched into a size of 5 cm (horizontal)×5 cm (vertical) using a punching machine. Each of the thickness of the punched electrode, the thickness of the aluminum foil and the specific resistance value (2.82E-06) of the current collector was input using Mp tester (HIOKI), and the punched electrode was placed below a tip in which a probe was embedded and measured by lowering the bar.

TABLE 1

| | | Example | Example | Example | Example | Example | Comparative | Comparative |
|---|---|---|---|---|---|---|---|---|
| | | 1 | 2 | 3 | 4 | 5 | example 1 | example 2 |
| Adhesion | First | Polymer | Polymer | Polymer | Polymer | Polymer | Polymer | Chitosan |
| enhancement | binder | A | A | A | B | A | A | (thermosetting |
| layer | | | | | | | | binder) |
| | First | 2:1 | 2:1 | 1:2 | 1:2 | 1:2 | 10:1 | 2:1 |
| | binder:First | | | | | | | |
| | conductive | | | | | | | |
| | material | | | | | | | |
| | (Weight | | | | | | | |
| | ratio) | | | | | | | |
| | Thickness | 200 | 400 | 400 | 400 | 400 | 100 | 400 |
| | (nm, one | | | | | | | |
| | side/contact | | | | | | | |
| | type) | | | | | | | |
| | Drying | 120 | 120 | 120 | 120 | 120 | 120 | 170 |
| | temperature | | | | | | | |
| | (° C.) | | | | | | | |
| | Al, F | 70.1, 2.6 | 46.3, 7.0 | 52.1, 3.5 | 50.3, 3.7 | 52.1, 3.5 | 81.2, 0.8 | 54.5, 0 |
| | content when | | | | | | | |
| | measured | | | | | | | |
| | by EDX | | | | | | | |
| | (weight %) | | | | | | | |
| | Ratio of F/Al | 0.037 | 0.085 | 0.067 | 0.074 | 0.067 | 0.010 | 0 |
| | contents when | | | | | | | |
| | measured | | | | | | | |
| | by EDX | | | | | | | |
| Positive | Type of | LFP | LFP | LFP | LFP | NCM | LFP | LFP |
| electrode | active | | | | | | | |
| active | material | | | | | | | |
| material | Thickness | 112 | 116 | 115 | 110 | 109 | 110 | 111 |
| layer | (um, before | | | | | | | |
| | pressing, | | | | | | | |
| | one side) | | | | | | | |
| | Thickness | 91 | 90 | 92 | 82 | 80 | 92 | 89 |
| | (um, after | | | | | | | |
| | pressing, | | | | | | | |
| | one side) | | | | | | | |
| Results | Adhesion | 47 | 55 | 54 | 51 | 62 | 72 | 8 (separation |
| | (gf/2 cm) | | | | | | | occurred) |
| | Interfacial | 1.1 | 0.2 | 0.1 | 0.1 | 0.04 | 3.6 (resistance | 0.5 |
| | resistance | | | | | | rise) | |
| | (Ω/cm²) | | | | | | | |
| Durability | Wet adhesion | 60 | 67 | 68 | 74 | 88 | 88 | 5 (separation |
| evaluation | strength | | | | | | | occurred) |
| (resistance | | | | | | | | |
| to dissolution | | | | | | | | |
| in electrolyte | | | | | | | | |
| solution) | | | | | | | | |

TABLE 2

| | | Example | Example | Example | Example | Example | Comparative | Comparative |
|---|---|---|---|---|---|---|---|---|
| | | 6 | 7 | 8 | 9 | 10 | example 3 | example 4 |
| Adhesion | First binder | Polymer | Polymer | Polymer | Polymer | Polymer | Polymer | Polymer |
| enhancement | | A | A | A | B | A | A | C |
| layer | First | 2:1 | 2:1 | 2:1 | 2:1 | 2:1 | 10:1 | 2:1 |
| | binder:First | | | | | | | |
| | conductive | | | | | | | |
| | material | | | | | | | |
| | (weight ratio) | | | | | | | |
| | Thickness | 200 | 400 | 300 | 300 | 300 | 200 | 300 |
| | (nm, one | | | | | | | |
| | side/contact | | | | | | | |
| | type) | | | | | | | |
| | Drying | 120 | 120 | 120 | 150 | 120 | 120 | 120 |
| | temperature | | | | | | | |
| | (° C.) | | | | | | | |
| | Coating phase | Island | Island | Island | Island | Island | Island | Island |
| | of binder | | | | | | | |
| | Surface | 119 | 522 | 252 | 217 | 252 | 82 | 278 |
| | roughness | | | | | | | |
| | (Ra) (nm) | | | | | | | |
| | Al, F content | 68.5, 2.8 | 50.2, 6.1 | 58.5, 5.8 | 57.4, 3.5 | 58.5, 5.8 | 80.1, 0.9 | 55.5, 0 |
| | when measured | | | | | | | |
| | by EDX | | | | | | | |
| | (weight %) | | | | | | | |
| | Ratio of F/Al | 0.0408 | 0.1215 | 0.0991 | 0.0609 | 0.0991 | 0.0112 | 0 |
| | contents when | | | | | | | |
| | measured by | | | | | | | |
| | EDX | | | | | | | |
| | Contact angle | 98 | 105 | 103 | 104 | 103 | 106 | 62 |
| | of a droplet (°) | | | | | | | |
| Positive | Type of active | LFP | LFP | LFP | LFP | NCM | LFP | LFP |
| electrode | material | | | | | | | |
| active | Thickness | 113 | 115 | 108 | 110 | 115 | 113 | 121 |
| material | (um, before | | | | | | | |
| layer | pressing, one | | | | | | | |
| | side) | | | | | | | |
| | Thickness | 89 | 91 | 85 | 88 | 89 | 87 | 90 |
| | (um, after | | | | | | | |
| | pressing, one | | | | | | | |
| | side) | | | | | | | |
| Results | Adhesion | 42 | 65 | 55 | 47 | 66 | 72 | 52 |
| | (gf/2 cm) | | | | | | | |
| | Interfacial | 1.2 | 0.2 | 0.5 | 0.8 | 0.03 | 4.8 (high | 3.1 (high |
| | resistance | | | | | | resistance) | resistance) |
| | (Ω/cm²) | | | | | | | |
| | Wet adhesion | (57) | 80 | 62 | 61 | 87 | 88 | 65 |
| | strength | | | | | | | |

1. A positive electrode current collector coated with an adhesion enhancement layer, comprising:
an aluminum foil current collector; and
an adhesion enhancement layer coated on at least one surface of the aluminum foil current collector, the adhesion enhancement layer comprising a first binder polymer, and a first conductive material,
wherein the adhesion enhancement layer comprises from 40 to 80 weight % of Al and from 1 to 10 weight % of F and has a ratio of F/Al contents of 0.0125 to 0.25 when measured on surfaces of the adhesion enhancement layer by energy-dispersive X-ray spectroscopy (EDX),
wherein the first binder polymer comprises a first polyvinylidene fluoride-based polymer.

2. The positive electrode current collector coated with the adhesion enhancement layer according to claim 1, wherein the first binder polymer is distributed in island arrays over the at least one surface of the aluminum foil current collector.

3. The positive electrode current collector coated with the adhesion enhancement layer according to claim 1, wherein the adhesion enhancement layer comprises from 45 to 75 weight % of Al and from 2 to 8 weight % of F when measured on surfaces of the adhesion enhancement layer by EDX.

4. The positive electrode current collector coated with the adhesion enhancement layer according to claim 1, wherein the adhesion enhancement layer has a ratio of F/Al contents of 0.027 to 0.178 when measured on surfaces of the adhesion enhancement layer by EDX.

5. The positive electrode current collector coated with the adhesion enhancement layer according to claim 1, wherein a surface roughness (Ra) of the adhesion enhancement layer is from 90 to 600 nm.

6. The positive electrode current collector coated with the adhesion enhancement layer according to claim 1, wherein the adhesion enhancement layer has a contact angle of a diiodomethane droplet of 700 to 120°.

7. The positive electrode current collector coated with the adhesion enhancement layer according to claim 1, wherein a melting point of the first polyvinylidene fluoride-based polymer is from 50° C. to 150° C.

8. The positive electrode current collector coated with the adhesion enhancement layer according to claim 1, wherein the first polyvinylidene fluoride-based polymer is a copolymer of vinylidene fluoride and hexafluoropropylene.

9. The positive electrode current collector coated with the adhesion enhancement layer according to claim 1, wherein a weight average molecular weight of the first polyvinylidene fluoride-based polymer is from 700,000 to 1,300,000.

10. The positive electrode current collector coated with the adhesion enhancement layer according to claim 1, wherein a weight ratio of the first polyvinylidene fluoride-based polymer and the first conductive material is from 0.5:1 to 8:1.

11. The positive electrode current collector coated with the adhesion enhancement layer according to claim 1, wherein a thickness of the adhesion enhancement layer on one surface of the at least one surface of the aluminum foil current collector is from 50 to 5,000 nm.

12. A positive electrode for a lithium secondary battery, comprising:
the positive electrode current collector coated with the adhesion enhancement layer according to claim 1; and
a positive electrode active material layer on the adhesion enhancement layer, the positive electrode active material layer comprising a positive electrode active material, a second conductive material, and a second binder polymer.

13. The positive electrode for the lithium secondary battery according to claim 12, wherein the positive electrode active material is represented by the following Formula 1:
Li₁₊ₐFe₁₋ₓMₓ(PO_{4-b})X_{b} <Formula 1>
wherein M is at least one selected from the group consisting of Al, Mg, Ni, Co, Mn, Ti, Ga, Cu, V, Nb, Zr, Ce, In, Zn and Y, X is at least one selected from the group consisting of F, S and N, −0.5≤a≤+0.5, 0≤x≤0.5, and 0≤b≤0.1.

14. The positive electrode for a lithium secondary battery according to claim 12, wherein the second binder polymer is a second polyvinylidene fluoride-based polymer.

15. A lithium secondary battery comprising:
the positive electrode according to claim 12;
a negative electrode;
a separator between the positive electrode and the negative electrode; and
an electrolyte.
